(19) United States
(12) Patent Application Publication
(10) Pub. No.: US 2012/0113960 A1
(43) Pub. Date: May 10, 2012

(54) Method and Apparatus to Support HSUPA During Baton Handover in TD-SCDMA Systems

(75) Inventors: Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/384,187

(22) PCT Filed: May 8, 2010
(86) PCT No.: PCT/US10/34155

§ 371 Date: Jan. 13, 2012

Related U.S. Application Data
(60) Provisional application No. 61/260,209, filed on Nov. 11, 2009.

(51) Int. Cl. H04W 36/00

(52) U.S. Cl. 370/331

(57) ABSTRACT

Certain aspects of the present disclosure propose techniques for continuing high-speed packet access (HSPA) during the baton handover in Target Cell Time Division Synchronous Code Division Multiple Access (TD-SCDMA) systems. In an aspect of the disclosure, a technique for performing a baton handover from a source node B (NB) to a target NB by a user equipment (UE) is provided. The technique generally includes receiving a first signal instructing the UE to perform the baton handover from the source NB to the target NB, transmitting data in uplink transmissions to the target NB during the baton handover, and receiving, from the source NB, information regarding the uplink transmissions.

### CROSS-REFERENCE TO RELATED APPLICATIONS

This application claims the benefit of U.S. Provisional Patent Application No. 61/260,209, entitled, “METHOD AND APPARATUS TO SUPPORT HSUPA DURING BATON HANDOVER IN TD-SCDMA SYSTEMS,” filed on Nov. 11, 2009, which is expressly incorporated by reference herein in its entirety.

### BACKGROUND

1. Field

Certain aspects of the present disclosure generally relate to wireless communications and, more particularly, to a method to continue high-speed uplink packet access (HSUPA) during a handover in Time Division Synchronous Code Division Multiple Access (TD-SCDMA) systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In an aspect of the disclosure, a method for performing a baton handover from a source node B (NB) to a target NB by a user equipment (UE) is provided. The method generally includes receiving a first signal instructing the UE to perform the baton handover from the source NB to the target NB, transmitting data in uplink transmissions to the target NB during the baton handover, and receiving, from the source NB, information regarding the uplink transmissions.

In an aspect of the disclosure, an apparatus for performing a baton handover from a source node B (NB) to a target NB by a user equipment (UE) is provided. The apparatus generally includes means for receiving a first signal instructing the UE to perform the baton handover from the source NB to the target NB, means for transmitting data in uplink transmissions to the target NB during the baton handover, and means for receiving, from the source NB, information regarding the uplink transmissions.

In an aspect of the disclosure, an apparatus for performing a baton handover from a source node B (NB) to a target NB by a user equipment (UE) is provided. The apparatus generally includes at least one processor configured to receive a first signal instructing the UE to perform the baton handover from the source NB to the target NB, transmit data in uplink transmissions to the target NB during the baton handover, and receive, from the source NB, information regarding the uplink transmissions.

In an aspect of the disclosure, a computer-program product for instructing a user terminal (UE) to perform a baton handover from a source NB to a target NB, the computer-program product is provided. The computer-program product generally includes a computer-readable medium comprising code for receiving a first signal instructing the UE to perform the baton handover from the source NB to the target NB, transmitting data in uplink transmissions to the target NB during the baton handover, and receiving, from the source NB, information regarding the uplink transmissions.

In an aspect of the disclosure, a method for instructing a user terminal (UE) to perform a baton handover from a source NB to a target NB is provided. The method generally includes sending a signal instructing the UE to perform the baton handover from the source NB to the target NB, continuing to transmit data to the UE during the baton handover, and receiving, from the target NB, uplink information regarding uplink transmissions from the UE to the target NB.

In an aspect of the disclosure, an apparatus for instructing a user terminal (UE) to perform a baton handover from a source NB to a target NB is provided. The apparatus generally includes means for sending a signal instructing the UE to perform the baton handover from the source NB to the target NB, means for continuing to transmit data to the UE during the baton handover, and means for receiving, from the target NB, uplink information regarding uplink transmissions from the UE to the target NB.

In an aspect of the disclosure, an apparatus for instructing a user terminal (UE) to perform a baton handover from a source NB to a target NB is provided. The apparatus generally includes at least one processor configured to send a signal instructing the UE to perform the baton handover from the source NB to the target NB, continue to transmit data to the UE during the baton handover, and receive, from the target NB, uplink information regarding uplink transmissions from the UE to the target NB; and a memory coupled to the at least one processor.

In an aspect of the disclosure, a computer-program product for instructing a user terminal (UE) to perform a baton handover from a source NB to a target NB is provided, the computer-program product generally includes a computer-readable medium comprising code for sending a signal instructing the UE to perform the baton handover from the source NB to the target NB, continuing to transmit data to the UE during the baton handover, and receiving, from the target NB, uplink information regarding uplink transmissions from the UE to the target NB.

In an aspect of the disclosure, a method for providing feedback to a user terminal (UE) during a baton handover from a source NB to a target NB is provided. The method generally includes receiving data in uplink transmissions from the UE during the baton handover and sending, to the source NB, uplink information regarding uplink transmissions from the UE to the target NB.

In an aspect of the disclosure, an apparatus for providing feedback to a user terminal (UE) during a baton handover from a source NB to a target NB is provided. The apparatus generally includes means for receiving data in uplink transmissions from the UE during the baton handover and means for sending, to the source NB, uplink information regarding uplink transmissions from the UE to the target NB.

In an aspect of the disclosure, an apparatus for providing feedback to a user terminal (UE) during a baton handover from a source NB to a target NB is provided. The apparatus generally includes at least one processor configured to receive data in uplink transmissions from the UE during the baton handover and to send, to the source NB, uplink information regarding uplink transmissions from the UE to the target NB.

In an aspect of the disclosure, a computer-program product for providing feedback to a user terminal (UE) during a baton handover from a source NB to a target NB is provided. The computer-program generally includes a computer-readable medium comprising code for receiving data in uplink transmissions from the UE during the baton handover and sending, to the source NB, uplink information regarding uplink transmissions from the UE to the target NB.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIGS. 4A-4C are diagrams conceptually illustrating an example of a baton handover.

FIG. 5 is a diagram conceptually illustrating an example relationship between channels in accordance with certain aspects of the present disclosure.

FIG. 6 is a diagram conceptually illustrating an example exchange of messages during a baton handover in accordance with certain aspects of the present disclosure.

FIG. 7 is a functional block diagram conceptually illustrating example blocks executed to implement the functional characteristics of one aspect of the present disclosure.

FIG. 8 is a functional block diagram conceptually illustrating example blocks executed to implement the functional characteristics of one aspect of the present disclosure.

FIG. 9 is a functional block diagram conceptually illustrating example blocks executed to implement the functional characteristics of one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

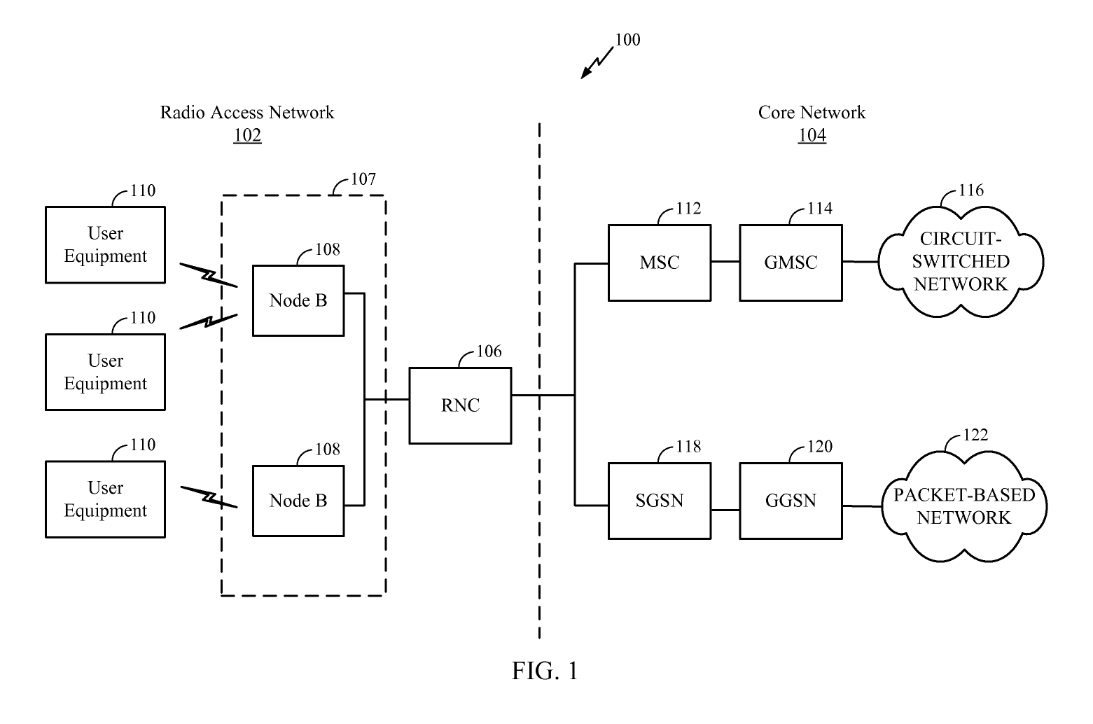

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

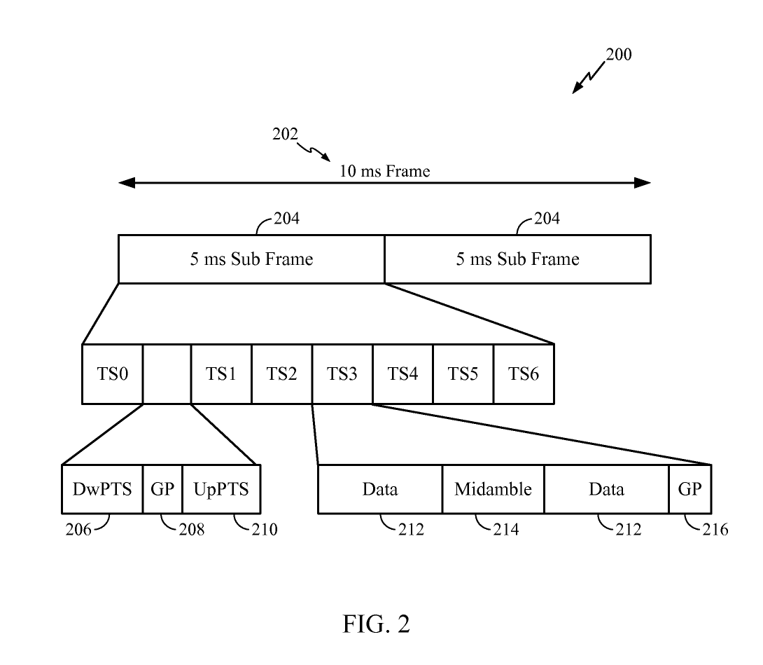

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

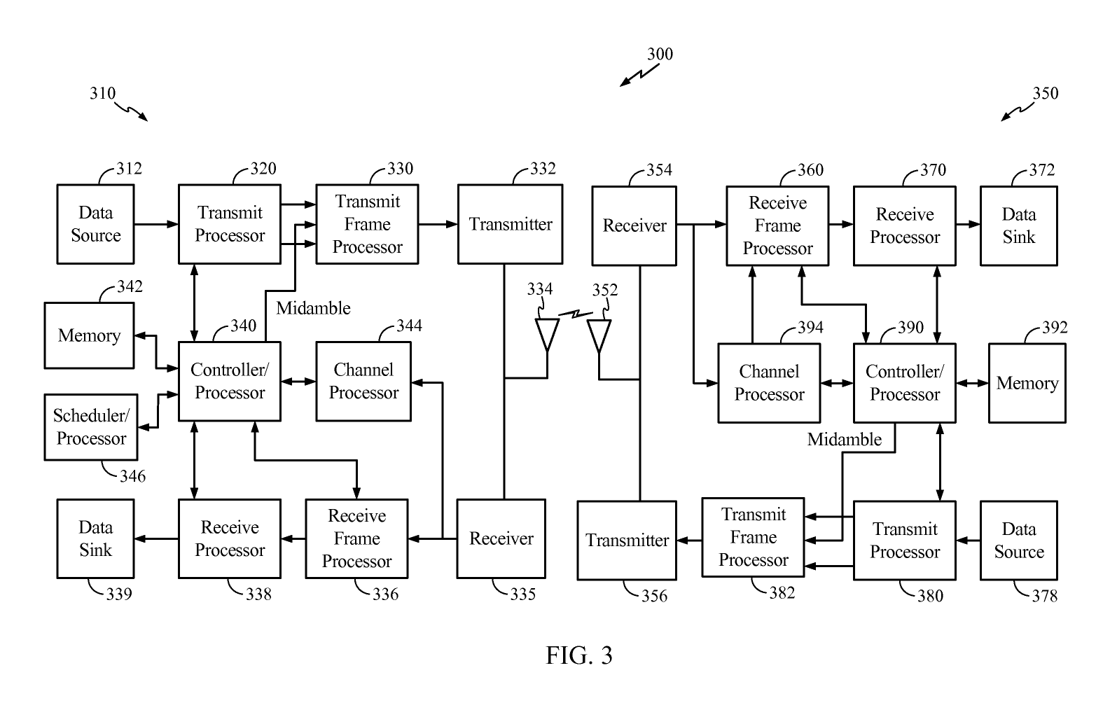

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

### Example Baton Handover

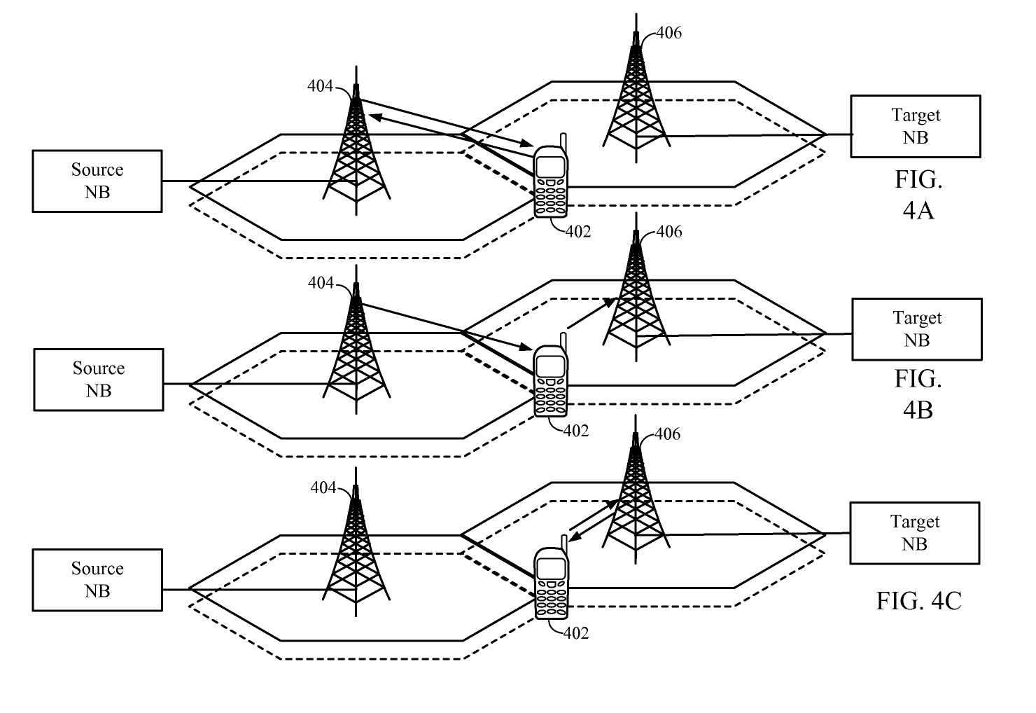

FIGS. 4A-4C illustrate an example of baton handover in the TD-SCDMA system, such as the system 100, in accordance with certain aspects of the present disclosure. As illustrated in FIG. 4A, a user equipment (UE) 402 may communicate on both downlink and uplink with a source cell and its Node B 404. The network may send (via the source NB) a PHYSICAL CHANNEL RECONFIGURATION message to the UE 402 to command the start of the baton handover. As illustrated in FIG. 4B, during a handover transition period, the UE 402 may switch the uplink to the target cell and its Node B 406, while still maintaining the downlink communications with the source cell and its Node B. Following this transition period, the UE 402 may finally switch the downlink to the target cell and its Node B 406, as illustrated in FIG. 4C.

The UE 402 may be able only to transmit or receive from one cell at one time, therefore during the transition period shown in FIG. 4B, the UE 402 may not be able to receive absolute grant and HARQ ACK/NACK messages from the target cell because the downlink may still remain in the source cell. As a result, in a conventional baton handover transition period, HSUPA may be disrupted.

Certain aspects of the present disclosure, however, may help allow high-speed uplink packet data transmission to continue while the baton handover is in progress. The techniques provided herein may allow higher data throughput to be achieved during the baton handover procedure than conventional systems.

### An Example Baton Handover with Continued HSUPA

The HSUPA operates according to a sequence. The NB sends on the E-AGCH (E-DCH Absolute Grant Channel) to the UE to indicate time slot and resource for sending the high-speed uplink data and which UE to receive the data. The UE sends on the E-PUCH (E-DCH Physical Uplink Channel) to the NB the high-speed uplink data. The UE receives on the E-HICH (E-DCH Hybrid ARQ Acknowledgement Indicator Channel) from the NB for the HARQ ACK/NACK of E-PUCH data transmission.

Although the UE may not be able to receive (absolute grant and HARQ ACK/NACK messages) directly from the target NB during the baton handover transition period, certain aspects of the present disclosure may allow a target NB to report absolute grant and/or acknowledgement information (ACK/NACK) back to the UE, via a downlink channel of the source NB. According to certain aspects, in order for the UE to accomplish this reporting via the target NB, defined timing relationships between the downlink data channels with the source NB and the reporting channels may need to be satisfied.

For example, according to certain aspects, the resource (TS and channelization code) for E-AGCH and E-HICH is given in the RADIO BEARER SETUP, RADIO BEARER RECONFIGURATION or PHYSICAL CHANNEL RECONFIGURATION messages. The channelization code may help the UE recognize ACK messages and associate them to the uplink transmissions that are being acknowledged.

According to certain aspects, a UE may be assigned with a number of shared E-AGCHs and up to 4 shared E-HICHs. A grant of E-PUCH resources is transmitted to the UE on any of the possible E-AGCHs. The E-AGCH may include an indication of which one of the 4 E-HICHs to be used.

One E-HICH may carry multiple ACK/NACK indicators. The ACK/NACK indicator may be scrambled using different signature sequences on the same Spreading Factor (e.g., SF=16) code channel. According to certain aspects, the scrambling sequence may depend on a variety of parameters, such as which subframe number, TS, and the code channel used for sending the data burst, as well as the cell midamble code. This has the implication that different scramble sequences may be used even for the burst transmission for different cells occurring at the same time using the same resources, because the cell-specific midamble codes are different.

The resources (TS and channelization code) to be used for E-AGCH and E-HICH may be given in the RADIO BEARER SETUP, RADIO BEARER RECONFIGURATION or PHYSICAL CHANNEL RECONFIGURATION messages.

There are specific timing for the E-AGCH, E-PUCH, and E-HICH. If E-AGCH is in subframe k, then:
E-PUCH is the second subframe after E-AGCH, k+2.
E-HICH is the second, third subframe after E-AGCH, k+2, k+3, etc. depending on the parameter n_{E-HICH}.
   The HARQ ACK may be synchronous, for example, defined to always occur n_{E-HICH} time slots (TSs) after E-PUCH burst transmission.

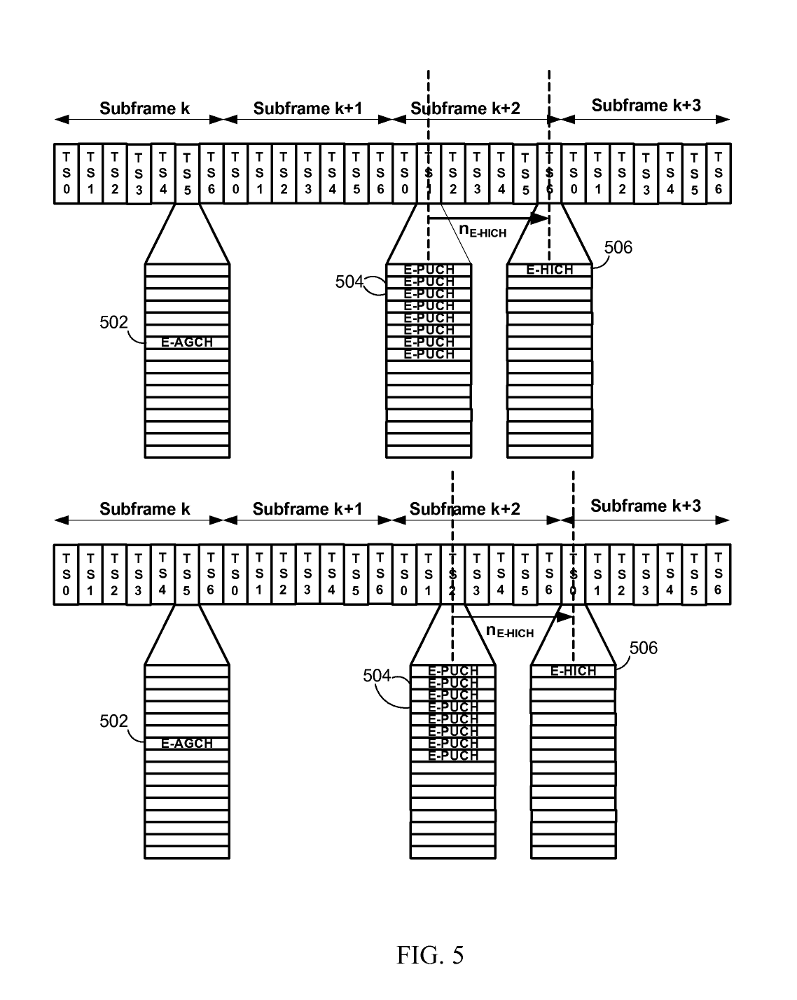

FIG. 5 illustrates this relationship and how E-HICH may occur k+2 or k+3 frames after E-AGCH, depending on the TS of E-PUCH, assuming that parameter n_{E-HICH}=5 TSs. In the first illustrated example in the top diagram, since an E-AGCH 502 occurs in (TS5 of) subframe k, E-PUCH 504 occurs in (TS1 of) subframe k+2, while E-HICH 506 occurs in (TS6 of) subframe k+2. In the illustrated example of the bottom diagram, E-AGCH 502 occurs in (TS5 of) subframe k, while E-PUCH 504 occurs in (TS2 of) subframe k+2, while E-HICH 506 occurs in (TS0 of) subframe k+3.

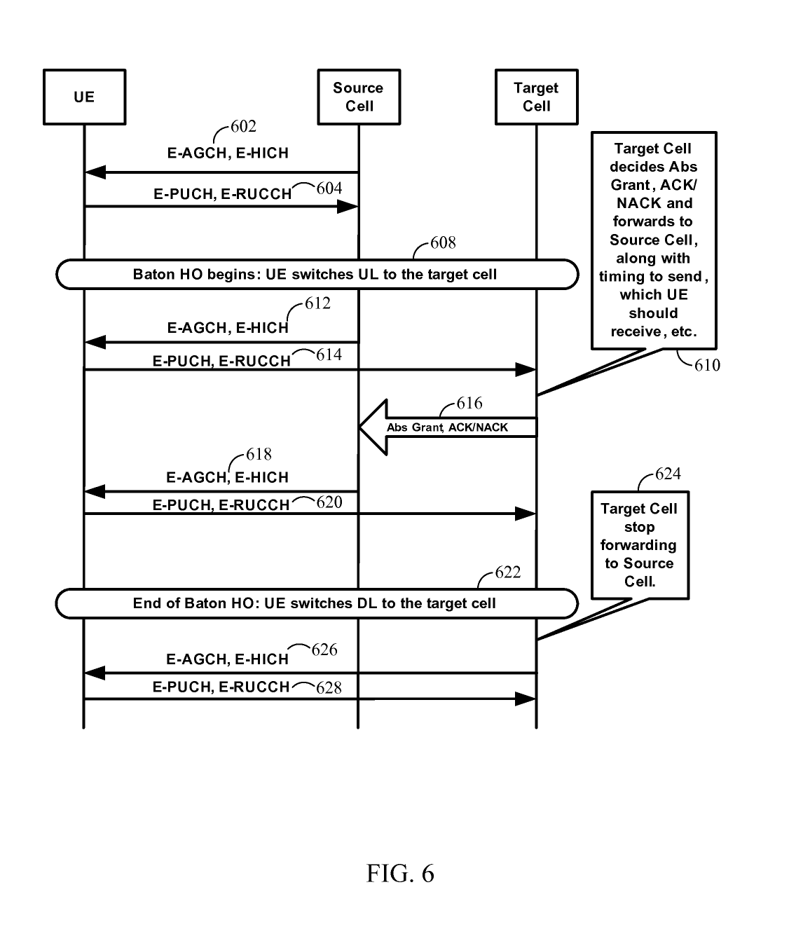

FIG. 6 illustrates an example exchange of messages during a baton handover of a UE from a NB in a source cell to a NB in a target cell, in accordance with certain aspects of the present disclosure.

As illustrated, the source cell may initially transmit control information to the UE via downlink channels 602 (i.e. E-AGCH, E-HICH), while the UE may transmit data to the source cell via uplink channels 604 (i.e. E-PUCH).

At 608, the baton handover transition period begins. For example, the baton handover may be triggered by the source cell sending the PHYSICAL CHANNEL RECONFIGURATION message to switch the UL channels of the UE. The PHYSICAL CHANEL RECONFIGURATION message also includes E-AGCH and E-HICH as well as E-PUSH and E-RUCCH information for the UE to be used in the target cell. The UE may switch to using uplink channels 614 (e.g., E-PUSH and E-RUCCH) of the target cell while maintaining downlink channels 612 with the source cell.

As noted at 610, the target NB may decide on Absolute Grants for the UE to use for uplink transmissions to the target NB, and also generate ACK/NACK messages, and forward these to the source NB, along with information indicating how the source NB should forward this information (e.g., timing information and which UE should receive the information).

At 616, the target NB transmits the absolute grant and ACK/NACK information to the source NB, to be forwarded to the UE. According to certain aspects, the UE continues to receive DL from the source cell at 618, including absolute grant and HARQ ACK/NACK received on the old E-AGCH and E-HICH of the source cell in order to know the absolute grant to be used and HARQ ACK/NACK of previous transmission on E-PUSH in the target cell.

Thus, as illustrated, while the UE is not able to receiving downlink data from the target NB, it may still receive absolute grant and ACK/NACK information generated by the target NB, forwarded to the UE via the source NB. The UE may, thus, continue high speed uplink transmissions (620), while the UE continues to receive information about how to send those transmissions and whether the target NB received those transmissions successfully.

Once the baton handover completes at 622 (e.g. the UE losing the DL, or a timer timeout), the target NB may stop forwarding the absolute grant and ACK/NACK information to the source NB, as noted at 624. The UE may switch the DL to the target cell (establishing DL channels 626), and establish UL channels 628.

In order to avoid collision with the HARQ ACK/NACK of the source cell, according to certain aspects, the source NB may use the midamble code sequence of the target NB to determine the scrambling signature in sending the relayed ACK/NACK (received from the target NB to be forwarded to the UE).

The target NB may need to send the information to the source NB, such as HARQ data burst decoding result of the received burst and which subframe, TS/code channel resource on E-PUCH for the received burst. With this information, the source NB can know how to decide on the scrambling sequence.

For the UE to receive the ACK/NACK (forwarded by the source NB), it may need to use the timing of transmitting the data burst and scrambling sequence determined by the proposed algorithm to descramble the ACK/NACK, as well as the nE-HICH parameter of the source cell to receive ACK/NACK in certain TS.

To comply with the synchronous ACK requirement, the target cell may need to choose the absolute grant so that there is E-HICH for the UE at the source cell to send ACK n_{E-HICH} (of the source cell) TSs later than E-PUCH transmission in target cell.

Therefore, the UE can know to expect to receive ACK/NACK on E-HICH of the source cell n_{E-HICH} (of the source cell) TSs after sending the data burst in the target cell. The TS when the source NB sends ACK/NACK on E-HICH can be indicated by the target cell, i.e., which subframe/TS on E-PUCH for received burst, and the n_{E-HICH} (of the source cell) parameter.

According to an aspect, the target NB can decide the absolute grant in advance and include the timing information (e.g., the subframe number) to transmit absolute grant by the source NB so that the timing for sending the absolute grant on E-AGCH can be two subframes ahead of actual data burst allocated by the target cell in order to comply with the timing relationship described above.

In addition, it may be desirable to have some indication by the target NB about which UE should receive absolute grant sent by the source NB. For example, the two cells (source and target) may use the IMSI (International Mobile Subscriber Identity) or P-TMSI (Packet Temporary Mobile Subscriber Identity) to do so. When the source NB receives the absolute grant from the target NB with IMSI/P-TMSI, it can use the corresponding E-RNTI of the IMSI/P-TMSI to send the absolute grant.

When the absolute grant is received by the UE, the UE can know when to transmit at the target NB.

Since sending ACK/NACKs is typically time critical (e.g., due to timeout limits), ideally, the source NB and the target NB should belong to the same NB. If they are of different NBs, then the RNC may play a role of relay, although in this case the latency may be higher. In order to allow this, the n_{E-HICH}-SOURCE parameter may be set to a larger value (than would otherwise be used if the source and target belonged to the same NB).

Ideally, the source cell will still keep the E-AGCH and E-HICH in order to relay the target NB absolute grant and HARQ ACK/NACK until the whole baton handover transition period is complete.

Once the baton handover completes, the target NB can transmit absolute grant and HARQ ACK/NACK on the new E-AGCH and E-HICH of the target cell. The explicit indication is when the target cell receives from the UE the PHYSICAL CHANNEL RECONFIGURATION COMPLETE message from the UE.

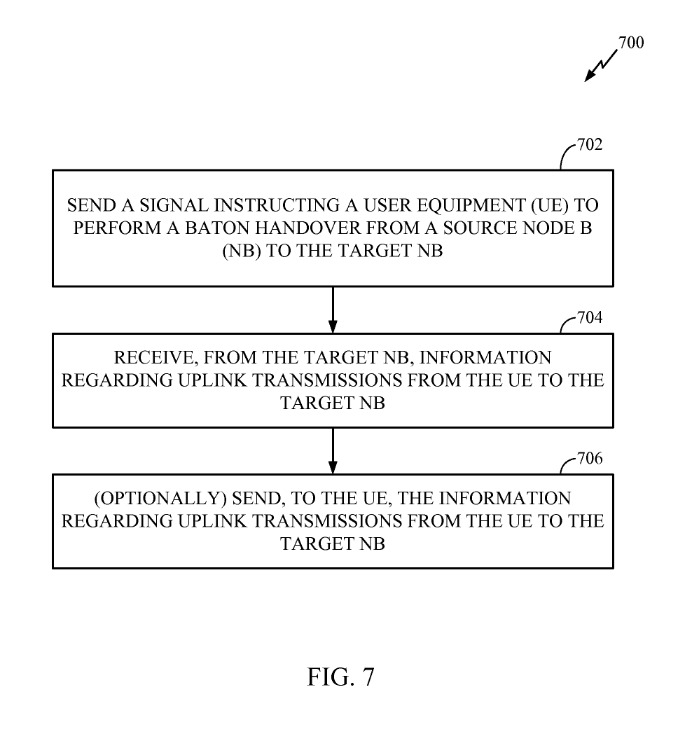

FIG. 7 illustrates example functional blocks corresponding to operations 700 that may be performed by a source NB to implement the functional characteristics of one aspect of the present disclosure.

At 702, the source NB sends a message instructing the UE to handover communications from the source sends a signal instructing the UE to perform the baton handover from the source NB to the target NB. For example, the signal may be in the form of a message including information regarding one or more channels for the UE to transmit data to the target NB during the baton handover. The source NB may continue to transmit information to the UE during the baton handover.

At 704, the source NB receiving, from the target NB, uplink information regarding uplink transmissions from the UE to the target NB. As noted above, the target NB may also include timing information and an identification of the UE to receive the information. At 706, the source NB may optionally forward the uplink information to the UE. As described above, the uplink information may include absolute grant information for sending uplink transmissions and/or acknowledgement information indicating whether previously sent uplink transmissions were successfully received by the target NB.

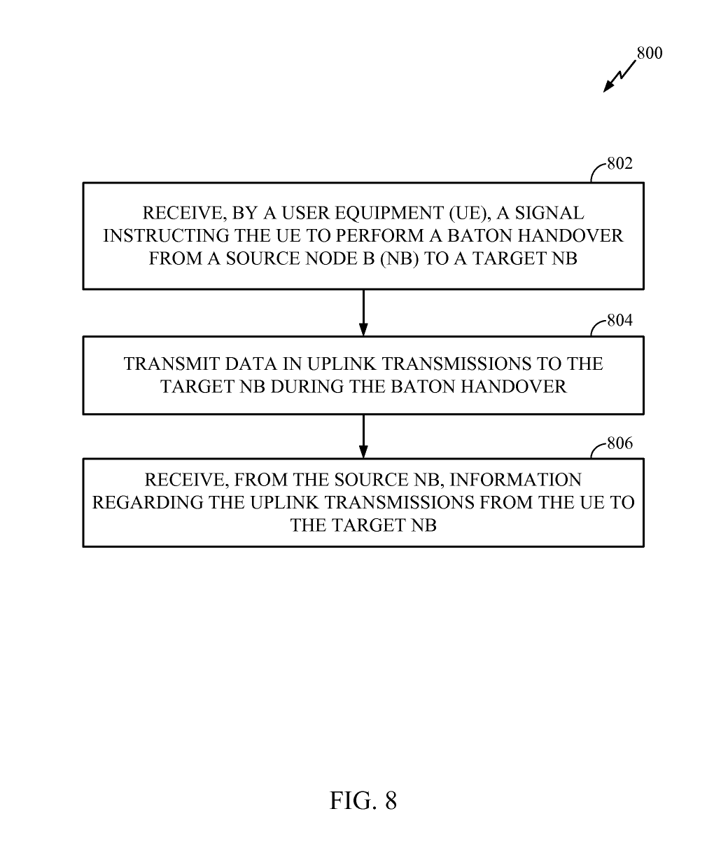

FIG. 8 illustrates example functional blocks corresponding to operations 800 that may be performed by a UE to implement the functional characteristics of one aspect of the present disclosure.

At 802, the UE receives a signal instructing the UE to perform the baton handover from the source NB to the target NB. The signal may be in the form of a message may including information about uplink channels with the target NB for transmitting data to the target NB during a handover transition period.

At 804, the UE transmits data in uplink transmissions to the target NB during the baton handover. At 806, the UE receives, from the source NB, information regarding the uplink transmissions. The uplink information may be generated by the target NB and transmitted to the source NB to be forwarded to the UE. The UE may subsequently send data to the target NB in uplink transmissions to the target NB, in accordance with the uplink information received from the source NB.

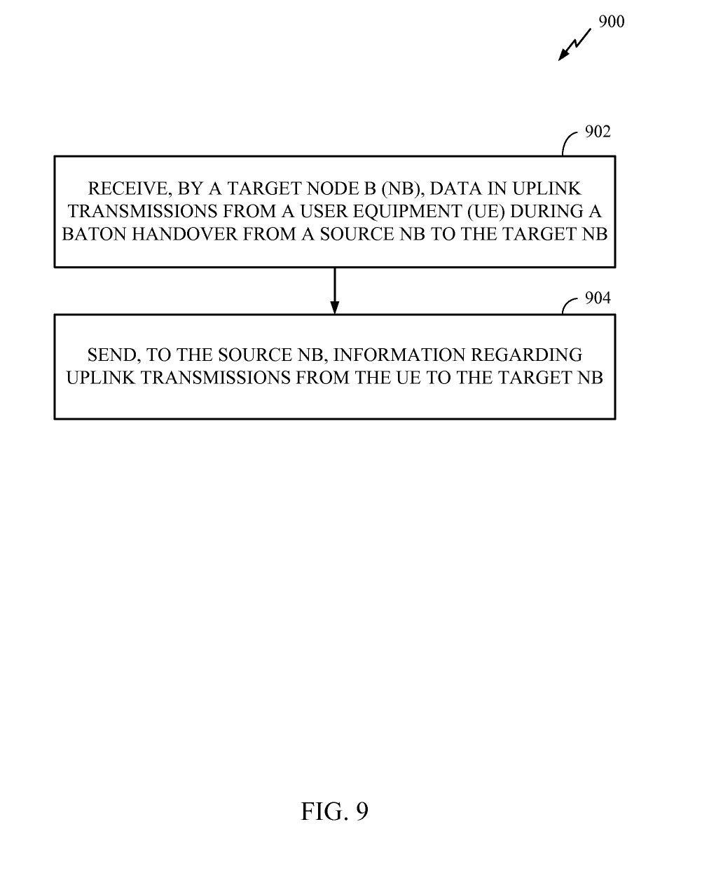

FIG. 9 illustrates example functional blocks corresponding to operations 900 that may be performed by a target NB to implement the functional characteristics of one aspect of the present disclosure.

At 902, the target NB receiving data in uplink transmissions from the UE during a baton handover. At 904, the target NB sends, to the source NB, uplink information regarding uplink transmissions from the UE to the target NB. The uplink information regarding uplink transmissions may be sent to the source NB to be forwarded to the UE by the source NB. The target NB may subsequently receive uplink transmissions from the UE, transmitted in accordance with the uplink information transmitted to the source NB.

In one configuration, an apparatus for wireless communication (e.g., the Node B 310 acting as a Source NB) includes means for sending a signal instructing the UE to perform the baton handover from the source NB to the target NB, means for continuing to transmit data to the UE during the baton handover, and means for receiving, from the target NB, uplink information regarding uplink transmissions from the UE to the target NB. In one aspect, the aforementioned means may be the transmit processor 320 or the controller/processor 340 configured to perform the functions recited by the aforementioned means. In another aspect, the aforementioned means may be a module or any apparatus configured to perform the functions recited by the aforementioned means.

In one configuration, the apparatus for wireless communication (e.g., the UE 350) includes means for receiving a first signal instructing the UE to perform the baton handover from the source NB to the target NB, means for transmitting data in uplink transmissions to the target NB during the baton handover, and means for receiving, from the source NB, information regarding the uplink transmissions. In one aspect, the aforementioned means may be the receive processor 370 or the controller/processor 390 configured to perform the functions recited by the aforementioned means. In another aspect, the aforementioned means may be a module or any apparatus configured to perform the functions recited by the aforementioned means.

In one configuration, an apparatus for wireless communication (e.g., the Node B 310 acting as a Target NB) includes means for receiving data in uplink transmissions from the UE during the baton handover and means for sending, to the source NB, uplink information regarding uplink transmissions from the UE to the target NB. In one aspect, the aforementioned means may be the transmit processor 320 or the controller/processor 340 configured to perform the functions recited by the aforementioned means. In another aspect, the aforementioned means may be a module or any apparatus configured to perform the functions recited by the aforementioned means.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for performing a baton handover from a source node B (NB) to a target NB by a user equipment (UE), comprising:
receiving a first signal instructing the UE to perform the baton handover from the source NB to the target NB;
transmitting data in uplink transmissions to the target NB during the baton handover; and
receiving, from the source NB, information regarding the uplink transmissions.

2. The method of claim 1, wherein the uplink information comprises acknowledgement information indicating whether data transmissions from the UE were successfully received by the target NB.

3. The method of claim 1, wherein the uplink information comprises absolute grant information indicating when uplink transmissions may be sent from the UE to the target NB.

4. The method of claim 1, wherein the message comprises a PHYSICAL CHANNEL RECONFIGURATION message.

5. The method of claim 1, wherein the uplink information is generated by the target NB and forwarded to the source NB.

6. The method of claim 1, further comprising transmitting subsequent data in uplink transmissions during the baton handover in accordance with the uplink information.

7. An apparatus for performing a baton handover from a source node B (NB) to a target NB by a user equipment (UE), comprising:
means for receiving a first signal instructing the UE to perform the baton handover from the source NB to the target NB;
means for transmitting data in uplink transmissions to the target NB during the baton handover; and
means for receiving, from the source NB, information regarding the uplink transmissions.

8. The apparatus of claim 7, wherein the uplink information comprises acknowledgement information indicating whether data transmissions from the UE were successfully received by the target NB.

9. The apparatus of claim 7, wherein the uplink information comprises absolute grant information indicating when uplink transmissions may be sent from the UE to the target NB.

10. The apparatus of claim 7, wherein the message comprises a PHYSICAL CHANNEL RECONFIGURATION message.

11. The apparatus of claim 7, wherein the uplink information is generated by the target NB and forwarded to the source NB.

12. The apparatus of claim 7, further comprising means for transmitting subsequent data in uplink transmissions during the baton handover in accordance with the uplink information.

13. An apparatus for performing a baton handover from a source node B (NB) to a target NB by a user equipment (UE), comprising:
at least one processor configured to:
receive a first signal instructing the UE to perform the baton handover from the source NB to the target NB;
transmit data in uplink transmissions to the target NB during the baton handover; and
receive, from the source NB, information regarding the uplink transmissions; and
a memory coupled to the at least one processor.

14. The apparatus of claim 13, wherein the uplink information comprises acknowledgement information indicating whether data transmissions from the UE were successfully received by the target NB.

15. The apparatus of claim 13, wherein the uplink information comprises absolute grant information indicating when uplink transmissions may be sent from the UE to the target NB.

16. The apparatus of claim 13, wherein the message comprises a PHYSICAL CHANNEL RECONFIGURATION message.

17. The apparatus of claim 13, wherein the uplink information is generated by the target NB and forwarded to the source NB.

18. The apparatus of claim 13, wherein the at least one processor is further configured to transmit subsequent data in uplink transmissions during the baton handover in accordance with the uplink information.

19. A computer-program product for instructing a user terminal (UE) to perform a baton handover from a source NB to a target NB, the computer-program product comprising:
a computer-readable medium comprising code for:
receiving a first signal instructing the UE to perform the baton handover from the source NB to the target NB;
transmitting data in uplink transmissions to the target NB during the baton handover; and
receiving, from the source NB, information regarding the uplink transmissions.

20. A method for instructing a user terminal (UE) to perform a baton handover from a source NB to a target NB, comprising:
sending a signal instructing the UE to perform the baton handover from the source NB to the target NB;
continuing to transmit data to the UE during the baton handover; and
receiving, from the target NB, uplink information regarding uplink transmissions from the UE to the target NB.

21. The method of claim 20, wherein the uplink information comprises acknowledgement information indicating whether data transmissions from the UE were successfully received by the target NB.

22. The method of claim 20, wherein the uplink information comprises absolute grant information indicating when uplink transmissions may be sent from the UE to the target NB.

23. The method of claim 20, further comprising forwarding the uplink information to the UE.

24. The method of claim 23, further comprising receiving information indicating when the uplink information is to be forwarded to the UE.

25. The method of claim 23, further comprising receiving information indicating how to scramble the uplink information when forwarding the uplink information to the UE.

26. The method of claim 23, further comprising:
determining a midamble code used by the target NB; and
based on the midamble code, determining a scrambling code to use in forwarding the uplink information to the UE.

27. An apparatus for instructing a user terminal (UE) to perform a baton handover from a source NB to a target NB, comprising:
means for sending a signal instructing the UE to perform the baton handover from the source NB to the target NB;
means for continuing to transmit data to the UE during the baton handover; and
means for receiving, from the target NB, uplink information regarding uplink transmissions from the UE to the target NB.

28. The apparatus of claim 27, wherein the uplink information comprises acknowledgement information indicating whether data transmissions from the UE were successfully received by the target NB.

29. The apparatus of claim 27, wherein the uplink information comprises absolute grant information indicating when uplink transmissions may be sent from the UE to the target NB.

30. The apparatus of claim 27, further comprising means for forwarding the uplink information to the UE.

31. The apparatus of claim 30, further comprising means for receiving information indicating when the uplink information is to be forwarded to the UE.

32. The apparatus of claim 31, further comprising means for receiving information indicating how to scramble the uplink information when forwarding the uplink information to the UE.

33. The apparatus of claim 31, further comprising:
means for determining a midamble code used by the target NB; and
means for determining, based on the midamble code, a scrambling code to use in forwarding the uplink information to the UE.

34. An apparatus for instructing a user terminal (UE) to perform a baton handover from a source NB to a target NB, comprising, comprising:
at least one processor configured to:
send a signal instructing the UE to perform the baton handover from the source NB to the target NB;
continue to transmit data to the UE during the baton handover; and
receive, from the target NB, uplink information regarding uplink transmissions from the UE to the target NB; and
a memory coupled to the at least one processor.

35. The apparatus of claim 34, wherein the uplink information comprises acknowledgement information indicating whether data transmissions from the UE were successfully received by the target NB.

36. The apparatus of claim 34, wherein the uplink information comprises absolute grant information indicating when uplink transmissions may be sent from the UE to the target NB.

37. The apparatus of claim 34, wherein the at least one processor is further configured to forward the uplink information to the UE.

38. The apparatus of claim 37, wherein the at least one processor is further configured to receive information indicating when the uplink information is to be forwarded to the UE.

39. The apparatus of claim 37, wherein the at least one processor is further configured to receive information indicating how to scramble the uplink information when forwarding the uplink information to the UE.

40. The apparatus of claim 37, wherein the at least one processor is further configured to:
determine a midamble code used by the target NB; and
based on the midamble code, determine a scrambling code to use in forwarding the uplink information to the UE.

41. A computer-program product for instructing a user terminal (UE) to perform a baton handover from a source NB to a target NB, the computer-program product comprising:
a computer-readable medium comprising code for:
sending a signal instructing the UE to perform the baton handover from the source NB to the target NB;
continuing to transmit data to the UE during the baton handover; and
receiving, from the target NB, uplink information regarding uplink transmissions from the UE to the target NB.

42. A method for providing feedback to a user terminal (UE) during a baton handover from a source NB to a target NB, comprising:
receiving data in uplink transmissions from the UE during the baton handover; and
sending, to the source NB, uplink information regarding uplink transmissions from the UE to the target NB.

43. An apparatus for providing feedback to a user terminal (UE) during a baton handover from a source NB to a target NB, comprising:
means for receiving data in uplink transmissions from the UE during the baton handover; and
means for sending, to the source NB, uplink information regarding uplink transmissions from the UE to the target NB.

44. The apparatus of claim 43, wherein the uplink information comprises acknowledgement information indicating whether data transmissions from the UE were successfully received by the target NB.

45. The apparatus of claim 43, wherein the uplink information comprises absolute grant information indicating when uplink transmissions may be sent from the UE to the target NB.

46. The apparatus of claim 43, wherein the uplink information is to be forwarded by the source NB to the UE.

47. The apparatus of claim 46, further comprising means for sending information indicating when the uplink information is to be forwarded by the source NB to the UE.

48. The apparatus of claim 46, further comprising means for sending information indicating how to scramble the uplink information when forwarded by the source NB to the UE.

49. An apparatus for providing feedback to a user terminal (UE) during a baton handover from a source NB to a target NB, comprising:
means for receiving data in uplink transmissions from the UE during the baton handover; and
means for sending, to the source NB, uplink information regarding uplink transmissions from the UE to the target NB.

50. The apparatus of claim 49, wherein the uplink information comprises acknowledgement information indicating whether data transmissions from the UE were successfully received by the target NB.

51. The apparatus of claim 49, wherein the uplink information comprises absolute grant information indicating when uplink transmissions may be sent from the UE to the target NB.

52. The apparatus of claim 49, wherein the uplink information is to be forwarded by the source NB to the UE.

53. The apparatus of claim 52, wherein the at least one processor is further configured to send information indicating when the uplink information is to be forwarded by the source NB to the UE.

54. The apparatus of claim 52, wherein the at least one processor is further configured to send information indicating how to scramble the uplink information when forwarded by the source NB to the UE.

55. A computer-program product for providing feedback to a user terminal (UE) during a baton handover from a source NB to a target NB, the computer-program product comprising:
a computer-readable medium comprising code for:
receiving data in uplink transmissions from the UE during the baton handover; and
sending, to the source NB, uplink information regarding uplink transmissions from the UE to the target NB.
